(19) United States
(12) Patent Application Publication
(10) Pub. No.: US 2019/0074908 A1
(43) Pub. Date: Mar. 7, 2019

(54) COHERENT OPTICAL RECEIVER FOR MEDIUM- AND SHORT-REACH LINKS

(71) Applicant: Nokia Solutions and Networks OY, Espoo (FI)

(72) Inventors: Sian Chong Lee, Summit, NJ (US); Vincent Houtsma, New Providence, NJ (US); Doutje van Veen, New Providence, NJ (US); Chen Zhu, Edison, NJ (US); Noriaki Kaneda, Westfield, NJ (US); Michael Eggleston, New York, NY (US)

(73) Assignee: Nokia Solutions and Networks OY, Espoo (FI)

(21) Appl. No.: 15/696,939

(22) Filed: Sep. 6, 2017

(51) Int. Cl. H04B 10/61; G06F 11/14

(52) U.S. Cl. CPC H04B 10/6162; G06F 2201/805; G06F 11/1443; H04B 10/611

(57) ABSTRACT

A coherent optical receiver having an analog electrical circuit connected to combine the outputs of multiple photodetectors to generate an electrical output signal from which the data encoded in a received modulated optical signal can be recovered in a robust and straightforward manner. In an example embodiment, the analog electrical circuit includes one or more transimpedance amplifiers connected between the photodetectors and the receiver's output port. The coherent optical receiver may include a dual-polarization optical hybrid coupled to eight photodiodes to enable polarization-insensitive detection of the received modulated optical signal. The signal processing implemented in the analog electrical circuit advantageously enables the use of relatively inexpensive local-oscillator sources that may have relaxed specifications with respect to linewidth and wavelength stability. Different embodiments of the analog electrical circuit can be used to enable the receiver to receive amplitude- and intensity-encoded modulated optical signals.

### BACKGROUND

### Field

The present disclosure relates to optical communication equipment and, more specifically but not exclusively, to a coherent optical receiver that can be used in medium- and/or short-reach links.

### Description of the Related Art

This section introduces aspects that may help facilitate a better understanding of the disclosure. Accordingly, the statements of this section are to be read in this light and are not to be understood as admissions about what is in the prior art or what is not in the prior art.

Optical receivers are often used in short- and medium-reach communication systems. Such receivers are represented by a very diverse group of devices, e.g., ranging from those directed to low-cost and/or high-volume applications to those providing extreme performance characteristics for niche and/or low-volume products. Different technical solutions and/or enabling technologies can be used to meet the specific requirements of each particular application. Such requirements may include one or more of: component density, power consumption, device cost, reach distance, performance benchmarks, etc. Several application-specific factors typically need to be considered before a suitable optical receiver can be designed and constructed for the intended application.

### SUMMARY OF SOME SPECIFIC EMBODIMENTS

Disclosed herein are various embodiments of a coherent optical receiver having an analog electrical circuit connected to combine the outputs of multiple photodetectors to generate an electrical output signal from which the data encoded in the received modulated optical signal can be recovered in a robust and straightforward manner. In an example embodiment, the analog electrical circuit includes one or more transimpedance amplifiers connected between the photodetectors and the receiver's output port. The coherent optical receiver may include a dual-polarization optical hybrid coupled to eight photodiodes to enable polarization-insensitive detection of the received modulated optical signal. The analog signal processing implemented in the analog electrical circuit advantageously enables the use of relatively inexpensive local-oscillator sources that may have relaxed specifications with respect to linewidth and wavelength stability while still being able to provide the significant benefits of coherent detection. Different embodiments of the analog electrical circuit can be used to enable the receiver to receive amplitude- and/or intensity-encoded modulated optical signals.

According to an example embodiment, provided is a apparatus comprising: an optical hybrid configured to generate a plurality of different optical interference signals by optically mixing an optical input signal and an optical local-oscillator signal; a plurality of photodetectors, each configured to generate a respective electrical signal in response to receiving a respective subset of the different optical interference signals from the optical hybrid; an analog electrical circuit connected to the plurality of photodetectors to generate an electrical output signal at an output port thereof in response to at least four of the respective electrical signals; and wherein the analog electrical circuit comprises a first transimpedance amplifier connected between the plurality of photodetectors and the output port.

According to another example embodiment, provided is a manufacturing method comprising the steps of: configuring an optical hybrid to generate a plurality of different optical interference signals by optically mixing an optical input signal and an optical local-oscillator signal; connecting a plurality of photodetectors to cause each of the photodetectors to generate a respective electrical signal in response to receiving a respective subset of the different optical interference signals from the optical hybrid; and connecting an analog electrical circuit to the plurality of photodetectors to cause the analog electrical circuit to generate an electrical output signal at an output port thereof in response to at least four of the respective electrical signals, said connecting including connecting a transimpedance amplifier between the plurality of photodetectors and the output port.

According to yet another example embodiment, provided is a communication method comprising the steps of: applying an optical input signal to an optical hybrid to generate a plurality of different optical interference signals by optically mixing therein said optical input signal and an optical local-oscillator signal; operating a plurality of photodetectors to cause each of the photodetectors to generate a respective electrical signal in response to receiving a respective subset of the different optical interference signals from the optical hybrid; and generating an electrical output signal using an analog electrical circuit connected to the plurality of photodetectors, the electrical output signal being generated at an output port of the analog electrical circuit in response to at least four of the respective electrical signals, said generating including using a transimpedance amplifier connected between the plurality of photodetectors and the output port.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a coherent optical receiver according to an embodiment;

FIG. 2 shows a block diagram of an analog electrical circuit that can be used in the coherent optical receiver of FIG. 1 according to an embodiment;

FIG. 3 shows a block diagram of an analog electrical circuit that can be used in the coherent optical receiver of FIG. 1 according to another embodiment;

FIG. 4 shows a block diagram of an analog electrical circuit that can be used in the coherent optical receiver of FIG. 1 according to yet another embodiment;

FIG. 5 shows a block diagram of an analog electrical circuit that can be used in the coherent optical receiver of FIG. 1 according to yet another embodiment;

FIG. 6 shows a block diagram of an optical-to-electrical converting circuit that can be used in the coherent optical receiver of FIG. 1 according to an alternative embodiment;

FIG. 7 shows a block diagram of a data-recovery circuit that can be used in conjunction with the coherent optical receiver of FIG. 1 according to an embodiment;

FIG. 8 shows a block diagram of a data-recovery circuit that can be used in conjunction with the coherent optical receiver of FIG. 1 according to another embodiment; and

FIG. 9 shows a block diagram of a communication system that can use one or more instances of the coherent optical receiver of FIG. 1 according to an embodiment.

### DETAILED DESCRIPTION

Optical links for access and datacenter-interconnect applications are typically limited by optical loss, which can be addressed as a receiver-sensitivity problem. Optical amplifiers may not be suitable for these applications due to relatively high cost and/or complexity of the resulting systems. As an alternative to optical amplifiers, coherent detection using a local oscillator (laser) can be used to provide coherent gain. The coherent gain can increase the receiver sensitivity, thereby enabling the use of longer optical links and/or supporting more users, e.g., in a passive-optical-network (PON) configuration.

Various embodiments disclosed herein are directed at providing a robust method and apparatus suitable for coherently detecting a modulated optical signal, e.g., received through a loss-limited medium/short-reach optical link. Some embodiments can be used to implement an optical receiver that can operate without the use of digital signal processing. Some embodiments can be used to reduce the cost of the optical receiver, e.g., by using, as a local oscillator, a laser whose output has a relatively large linewidth.

Some of the disclosed embodiments can provide one or more of the following benefits and/or advantages:
(i) operate in a polarization-insensitive manner;
(ii) not require polarization tracking;
(iii) provide enhanced sensitivity, e.g., due to the use of balanced detection schemes;
(iv) utilize a non-linear electrical (e.g., trans-impedance or functionally similar) amplifier;
(v) be suitable for burst-mode operation; and
(vi) repurpose some of the readily available off-the-shelf parts, such as those already commercially produced in relatively large quantities.

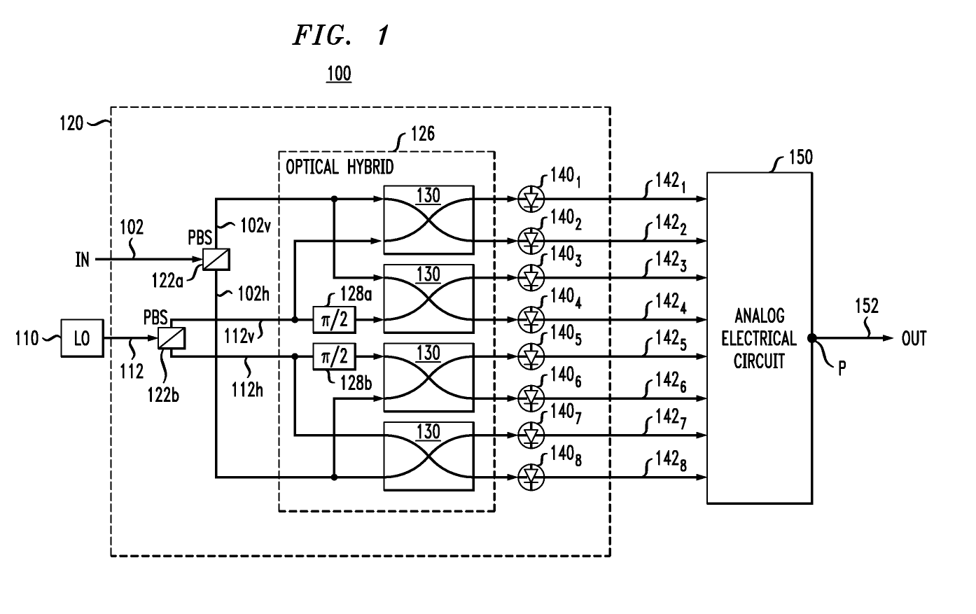

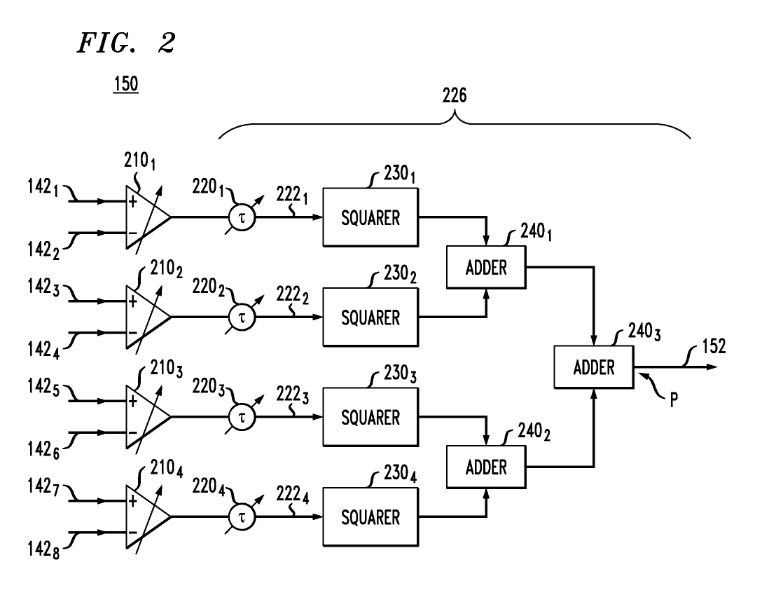

FIG. 1 shows a block diagram of a coherent optical receiver 100 according to an embodiment. Receiver 100 is configured to receive a modulated optical input signal 102, e.g., from a remote transmitter, via an external optical communication link (e.g., an fiber, not explicitly shown in FIG. 1). Optical input signal 102 is applied to an optical-to-electrical (O/E) converter 120 that converts this signal into eight electrical signals 142₁-142₈. An analog electrical circuit 150 then combines electrical signals 142₁-142₈ to generate at an output port P an electrical output signal 152, from which the data encoded in modulated optical input signal 102 can be recovered in a conventional manner. Example analog electrical circuits that can be used to implement circuit 150 are described in more detail below in reference to FIGS. 2-6.

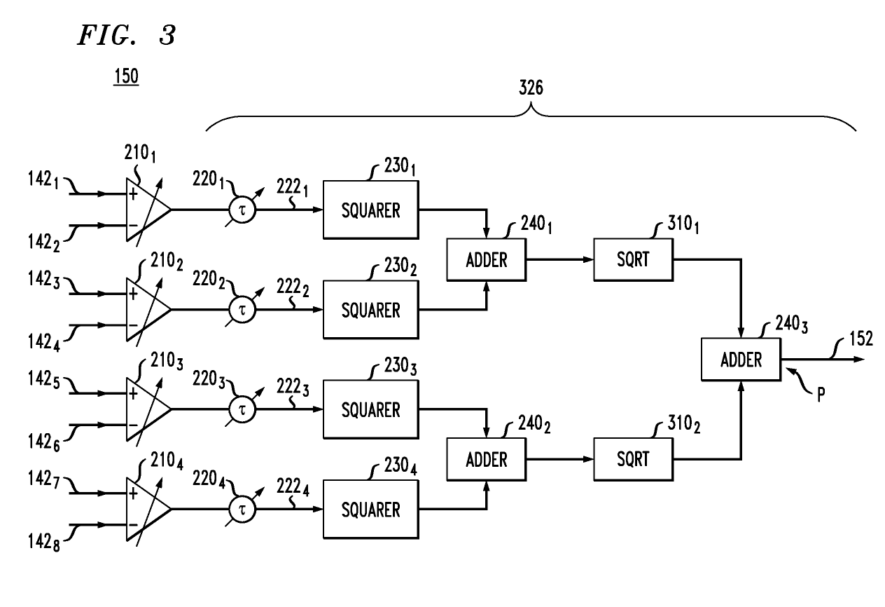

In an example embodiment, optical input signal 102 is not polarization-division multiplexed. As a result, in each time slot, optical input signal 102 applies a single optical symbol to receiver 100. Depending on the type of modulation used at the remote transmitter, the optical symbol may encode one bit (e.g., using on/off keying, OOK) or multiple bits (e.g., using pulse amplitude modulation, PAM). In the latter case, the bit-word value carried by the optical symbol may be encoded in the amplitude thereof or in the intensity (e.g., squared amplitude) thereof. Embodiments of analog electrical circuit 150 that can be used for processing the amplitude-encoded optical signals are described in reference to FIGS. 3, 5, and 6. Embodiments of analog electrical circuit 150 that can be used for processing the intensity-encoded optical signals are described in reference to FIGS. 2, 4, and 6. Each of the embodiments of analog electrical circuit 150 shown in FIGS. 2-6 can be used for processing OOK signals. When coupled with a digital signal processor (DSP), e.g., as indicated in FIG. 8, each of the embodiments of analog electrical circuit 150 shown in FIGS. 2-6 can be used for processing both amplitude- and intensity-encoded optical signals.

O/E converter 120 is configured to generate electrical signals 142₁-142₈ using an optical local-oscillator (LO) signal 112 supplied by a laser 110. In some embodiments, laser 110 can be tunable and, as such, capable of changing the carrier wavelength of LO signal 112, e.g., to enable detection of any selected channel of a wavelength-division-multiplexed (WDM) channel set.

In an example embodiment, O/E converter 120 comprises polarization beam splitters (PBSs) 122a and 122b configured to decompose optical signals 102 and 112, respectively, into two respective orthogonally polarized components, illustratively vertically polarized components 102v and 112v and horizontally polarized components 102h and 112h. Polarization components 102v, 112v, 102h, and 112h are applied to an optical hybrid 126. The internal structure of optical hybrid 126 shown in FIG. 1 is an example structure shown for illustration purposes. An optical hybrid 126 having an alternative internal structure can similarly be used, e.g., as would be readily understood by a person of ordinary skill in the pertinent art.

As shown, optical hybrid 126 is configured to split each of polarization components 102v, 112v, 102h, and 112h into two respective (attenuated) copies, e.g., using a conventional 3-dB power splitter (not explicitly shown in FIG. 1). A relative phase shift of about 90 degrees (π/2 radian) is then applied to one copy of component 112v and one copy of component 112h using phase shifters 128a and 128b, respectively. The various copies of signals 102v, 112v, 102h, and 112h are then optically mixed with each other as indicated in FIG. 1 using four optical signal mixers 130. The resulting eight mixed (e.g., optical interference) signals produced by mixers 130 are detected by eight photo-detectors (e.g., photodiodes) 140₁-140₈. The eight electrical signals generated by photodiodes 140₁-140₈ are electrical signals 142₁-142₈.

As used herein, the term “optical hybrid” refers to an optical mixer designed to mix a first optical input signal having a carrier frequency and a second optical input signal having approximately the same (e.g., to within ±10 GHz) carrier frequency to generate a plurality of mixed optical signals corresponding to different relative phase shifts between the two optical input signals. An optical 90-degree hybrid is a particular type of an optical hybrid that is designed to produce at least four mixed optical signals corresponding to the relative phase shifts between the two optical input signals of approximately 0, 90, 180, and 270 degrees, respectively (e.g., to within an acceptable tolerance). Depending on the intended application, the acceptable relative phase-shift tolerances can be, e.g., to within ±5 degrees or ±10 degrees, etc. A person of ordinary skill in the art will understand that each of the relative phase shifts is defined without accounting for a possible additional phase shift that is an integer multiple of 360 degrees. A dual-polarization optical hybrid, such as optical hybrid 126, operates to perform the above-indicated optical signal mixing on a per-polarization basis.

Example optical hybrids that can be used as optical hybrid 126 in some alternative embodiments of O/E converter 120 are disclosed, e.g., in U.S. Pat. Nos. 7,809,284 and 8,275,224, both of which are incorporated herein by reference in their entirety.

The signal processing implemented in analog electrical circuit 150 advantageously enables the use of relatively inexpensive LO sources 110 that may have relaxed specifications with respect to linewidth and wavelength stability when used for detecting amplitude/intensity-modulated signals. For example, in a representative embodiment of receiver 100, it may be acceptable for LO signal 112 to have a relatively large linewidth and/or be not precisely spectrally aligned with optical input signal 102. In conventional systems, the relatively large linewidth typically causes an unacceptable level of phase noise, and the carrier-wavelength mismatch between the input and LO signals typically requires the use of elaborate carrier-offset compensation schemes. In contrast, computer simulations of some embodiments of receiver 100 indicate that electrical output signal 152 has a good-quality (e.g., widely open) eye diagram even when the carrier frequency of LO signal 112 deviates from the carrier frequency of optical input signal 102 by as much as ±150% of the baud rate of the latter signal.

FIG. 2 shows a block diagram of analog electrical circuit 150 that can be used in coherent optical receiver 100 (FIG. 1) according to an embodiment. Electrical input signals 142₁-142₈, output port P, and electrical output signal 152 are also shown in FIG. 2 to better illustrate the relationship between the circuits of FIGS. 1 and 2.

Circuit 150 of FIG. 2 comprises transimpedance amplifiers (TIAs) 210₁-210₄. TIA 210₁ is connected to receive electrical input signals 142₁ and 142₂ at the positive and negative inputs thereof, respectively. TIA 210₂ is connected to receive electrical input signals 142₃ and 142₄ at the positive and negative inputs thereof, respectively. TIA 210₃ is connected to receive electrical input signals 142₅ and 142₆ at the positive and negative inputs thereof, respectively. TIA 210₄ is connected to receive electrical input signals 142₇ and 142₈ at the positive and negative inputs thereof, respectively.

In some embodiments, TIAs 210₁-210₄ can be variable gain amplifiers, as indicated in FIG. 2. Such embodiments can be used, e.g., in communication systems in which optical signal 102 can undergo relatively large intensity fluctuations. An example of such a system is a PON system in which different transmitters connected to communicate with receiver 100 are located at different respective distances therefrom, with the range of distances being such that the corresponding optical links suffer from significantly different respective optical losses therein.

In some embodiments, TIAs 210₁-210₄ can be designed and configured for burst-mode operation.

As used herein, the term “burst mode” refers to an operating mode in which relatively short time periods during which the optical receiver (e.g., receiver 100, FIG. 1) receives data-modulated optical signals are separated by idle intervals during which the optical receiver does not receive any optical signals. In some systems, the idle intervals may be much longer than the data-burst intervals. In some other systems, the idle intervals can be guard intervals configured to prevent collision and/or interference of data bursts transmitted to the same optical receiver by different transmitters.

TIAs that can be used to implement TIAs 210₁-210₄ configured for burst-mode operation are disclosed, e.g., in U.S. Pat. Nos. 7,583,904 and 9,673,797 and International Patent Application No. WO 2011/109770, all of which are incorporated herein by reference in their entirety.

Circuit 150 of FIG. 2 further comprises an analog signal-processing circuit 226 that may have optional tunable delay elements (e.g., phase shifters) 220₁-220₄ connected to the outputs of TIAs 210₁-210₄, respectively. Delay elements 220₁-220₄ can be used to apply relatively small time delays (phase shifts) whose values can be appropriately selected to compensate for skew between the four different signal channels corresponding to TIAs 210₁-210₄. The resulting skew-compensated electrical signals are labeled in FIG. 2 as signals 222₁-222₄, respectively. The use of delay elements 220₁-220₄ in circuit 150 can be beneficial, e.g., in that it can improve certain performance characteristics and/or relieve some design constraints for the downstream signal-processing circuits.

Analog signal-processing circuit 226 is configured to convert electrical signals 222₁-222₄ into electrical output signal 152 in accordance with the following approximate formula:

Vₒᵤₜ∝|X_{I}|²+|X_{Q}|²+|Y_{I}|²+|Y_{Q}|² (1)

where Vₒᵤₜ is the voltage of electrical output signal 152; and X_{I}, X_{Q}, Y_{I}, and Y_{Q} denote the instantaneous amplitudes of electrical signals 222₁-222₄, respectively. A person of ordinary skill in the art will understand that the value of Vₒᵤₜ expressed by Eq. (1) provides a measure of the intensity (optical power) of optical input signal 102. As such, the embodiment of circuit 150 shown in FIG. 2 is more suitable for processing electrical signals corresponding to an optical input signal 102 that has been generated using intensity (as opposed to amplitude) modulation.

In an example embodiment, analog signal-processing circuit 226 comprises squaring circuits 230₁-230₄ and adders 240₁-240₃ connected as indicated in FIG. 2.

Each of squaring circuits 230₁-230₄ operates to generate a respective electrical output signal whose amplitude is proportional to the square of the amplitude of the respective one of electrical signals 222₁-222₄. In an example embodiment, a squaring circuit 230 can be implemented using an analog multiplier whose two inputs are connected to one another and further connected to receive the corresponding electrical signal 222.

Each of adders 240₁-240₃ operates to generate a respective electrical output signal that is a sum of the two respective input signals. In an example embodiment, an adder 240 can be implemented using an operational amplifier, e.g., configured as known in the pertinent art.

FIG. 3 shows a block diagram of analog electrical circuit 150 that can be used in coherent optical receiver 100 (FIG. 1) according to another embodiment. The embodiments of circuit 150 shown in FIGS. 2 and 3 share many of the same elements, which are labeled using the same reference labels. For the description of these elements the reader is referred to the description of FIG. 2 given above. The description of FIG. 3 provided below mainly focuses on the differences between the circuits shown in FIGS. 2 and 3.

One difference between the embodiments of circuit 150 shown in FIGS. 2 and 3 is that the embodiment shown in FIG. 3 has analog signal-processing circuit 326 instead of analog signal-processing circuit 226 (see FIG. 2). Analog signal-processing circuit 326 (FIG. 3) differs from analog signal-processing circuit 226 (FIG. 2) in that it includes analog square-root (SQRT) generators 310₁ and 310₂. Square-root generator 310₁ is inserted between adders 240₁ and 240₃. Square-root generator 310₂ is similarly inserted between adders 240₂ and 240₃. As a result, analog signal-processing circuit 326 operates to convert electrical signals 222₁-222₄ into electrical output signal 152 in accordance with the following approximate formula:

Vₒᵤₜ∝\sqrt{|X_{I}|²+|X_{Q}|²}+\sqrt{|Y_{I}|²+|Y_{Q}|²} (2)

A person of ordinary skill in the art will understand that the value of Vₒᵤₜ expressed by Eq. (2) can be used as an approximate measure of the electric-field strength (amplitude) of optical input signal 102. As such, the embodiment of analog signal combiner 150 shown in FIG. 3 is better suitable for processing electrical signals corresponding to an optical input signal 102 that has been generated using amplitude (as opposed to intensity) modulation.

In an example embodiment, a square-root generator 310 can be implemented using an operational amplifier and an analog signal multiplier, with the latter being appropriately connected in the feedback loop of the operational amplifier.

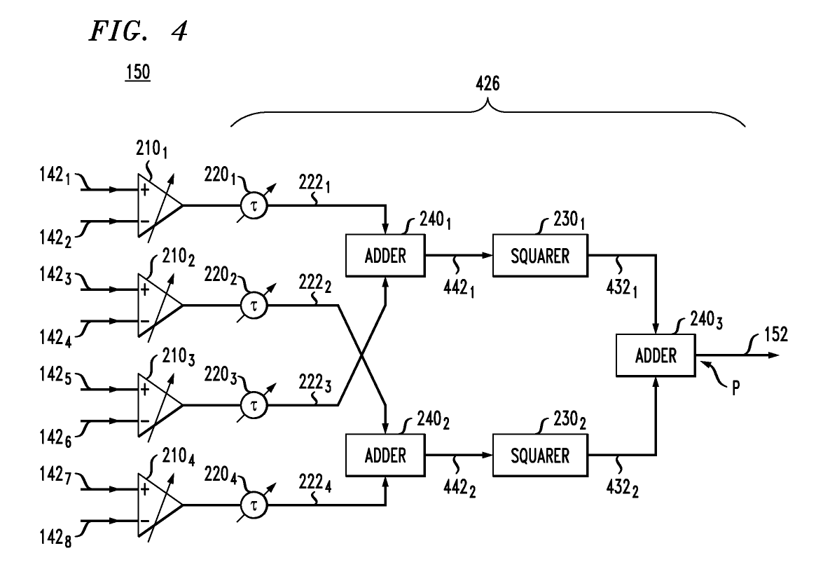

FIG. 4 shows a block diagram of analog electrical circuit 150 that can be used in coherent optical receiver 100 (FIG. 1) according to yet another embodiment. The embodiment of circuit 150 shown in FIG. 4 uses many of the circuit components previously described in reference to FIGS. 2 and 3. These components are labeled in FIG. 4 using the same reference labels as in FIGS. 2 and 3. However, some of these circuit components are arranged differently in the embodiment of circuit 150 shown in FIG. 4, as described in more detail below.

Circuit 150 of FIG. 4 comprises an analog signal-processing circuit 426 configured to convert electrical signals 222₁-222₄ into electrical output signal 152 in accordance with the following approximate formula:

Vₒᵤₜ∝|X_{I}+Y_{I}|²+|X_{Q}+Y_{Q}|² (3)

A person of ordinary skill in the art will understand that the value of Vₒᵤₜ expressed by Eq. (3) provides a measure of the intensity (optical power) of optical input signal 102. As such, the embodiment of circuit 150 shown in FIG. 4 is more suitable for processing electrical signals corresponding to an optical input signal 102 that has been generated using intensity (as opposed to amplitude) modulation.

In an example embodiment, analog signal-processing circuit 426 comprises squaring circuits 230₁ and 230₂ and adders 240₁-240₃ connected as indicated in FIG. 4. More specifically, adder 240₁ is configured to generate an electrical signal 442₁ that is a sum of electrical signals 222₁ and 222₃. Adder 240₂ is similarly configured to generate an electrical signal 442₂ that is a sum of electrical signals 222₂ and 222₄. Squaring circuit 230₁ is configured to generate an electrical signal 432₁ whose amplitude is proportional to the square of the amplitude of electrical signal 442₁. Squaring circuit 230₂ is similarly configured to generate an electrical signal 432₂ whose amplitude is proportional to the square of the amplitude of electrical signal 442₂. Adder 240₃ is configured to generate a sum of electrical signals 432₁ and 432₂, thereby generating electrical output signal 152.

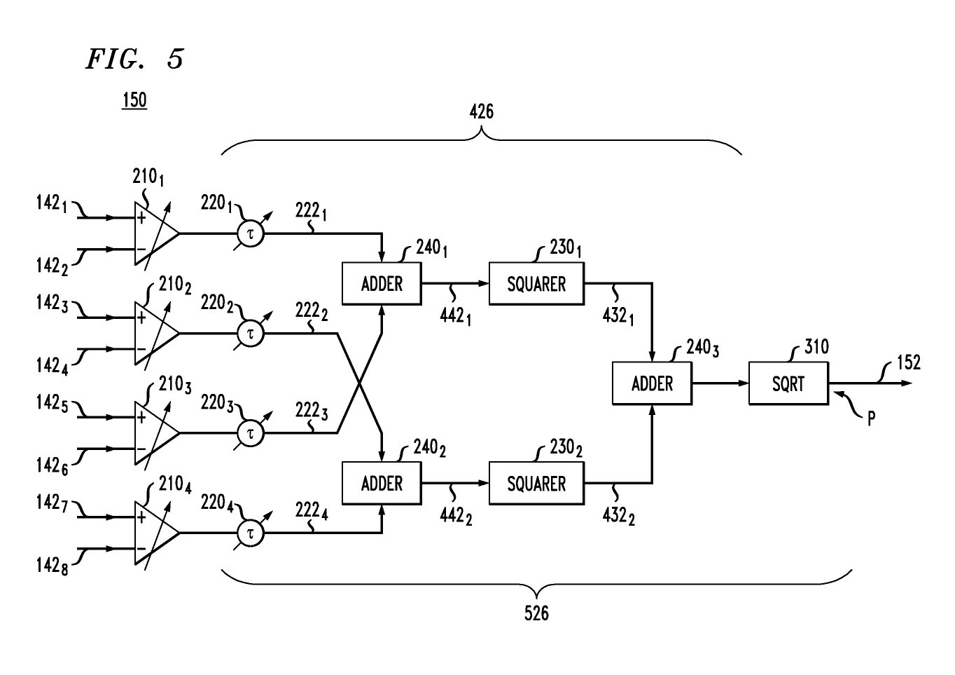

FIG. 5 shows a block diagram of analog electrical circuit 150 that can be used in coherent optical receiver 100 (FIG. 1) according to yet another embodiment. The embodiment of circuit 150 shown in FIG. 5 differs from the embodiment of circuit 150 shown in FIG. 4 in that it additionally has an analog square-root generator 310 connected to the output of analog signal-processing circuit 426. A resulting combined analog signal-processing circuit 526 operates to convert electrical signals 222₁-222₄ into electrical output signal 152 in accordance with the following approximate formula:

Vₒᵤₜ∝\sqrt{|X_{I}+Y_{I}|²+|X_{Q}+Y_{Q}|²} (4)

A person of ordinary skill in the art will understand that the value of Vₒᵤₜ expressed by Eq. (4) can be used as an approximate measure of the electric-field strength (amplitude) of optical input signal 102. As such, the embodiment of circuit 150 shown in FIG. 4 is better suitable for processing electrical signals corresponding to an optical input signal 102 that has been generated using amplitude (as opposed to intensity) modulation.

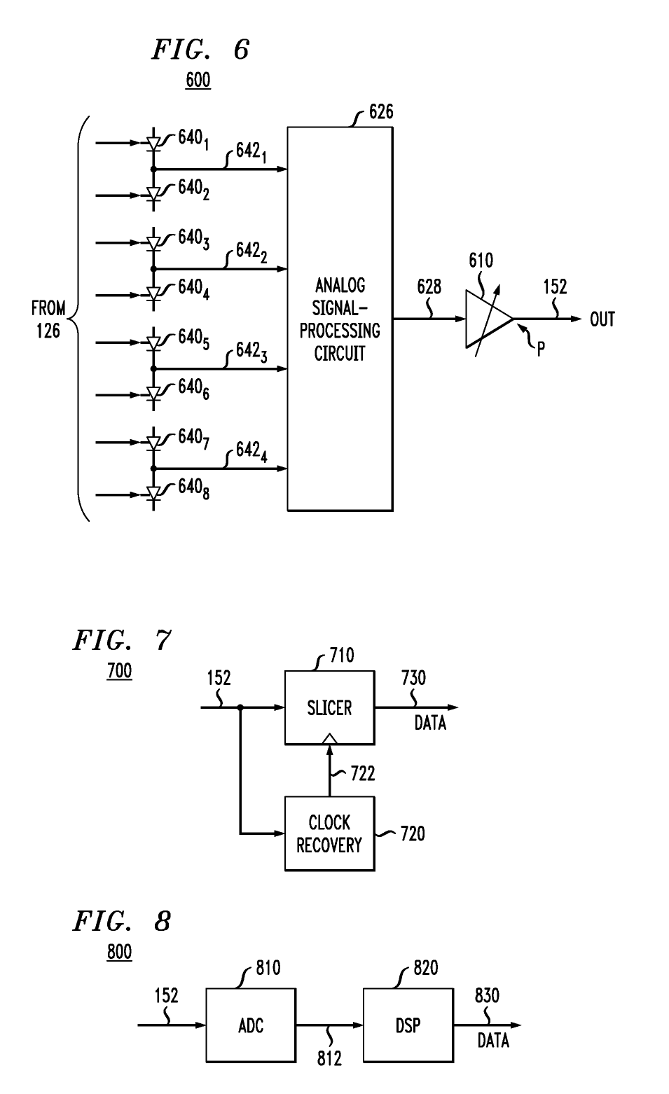

FIG. 6 shows a block diagram of an O/E-converting circuit 600 that can be used in coherent optical receiver 100 (FIG. 1) according to an alternative embodiment. More specifically, circuit 600 is designed to replace the array of photodiodes 140₁-140₈ and analog electrical circuit 150 (see FIG. 1).

Circuit 600 comprises an array of photodiodes 640₁-640₈ arranged in pairs, as shown in FIG. 6, to form four balanced photodiode pairs, each pair operating as a photodetector. The four electrical output signals generated by these photodetectors are labeled in FIG. 6 as signals 642₁-642₄.

Circuit 600 further comprises an analog signal-processing circuit 626 and a TIA 610. In different embodiments, analog signal-processing circuit 626 can be a nominal copy of one of the above-described analog signal-processing circuits 226, 326, 426, and 526 (see FIGS. 2-5). When used in the configuration shown in FIG. 6, each of analog signal-processing circuits 226, 326, 426, and 526 is configured to receive electrical signals 642₁-642₄. An electrical signal 628 generated by analog signal-processing circuit 626 is applied to TIA 610 in a single-ended configuration. The electrical output signal generated by TIA 610 in response to electrical signal 628 is electrical output signal 152 applied to output port P (also see FIG. 1).

For some applications, the use of circuit 600 instead of the circuits described in reference to FIGS. 2-5 may be beneficial in that circuit 600 is configured to use a single TIA 610 instead of four TIAs 210₁-210₄. Depending on the particular embodiment of analog signal-processing circuit 626, circuit 600 can operate to convert electrical signals 642₁-642₄ into electrical output signal 152 in accordance with any one of Eqs. (1)-(4).

FIG. 7 shows a block diagram of a data-recovery circuit 700 that can be used in conjunction with coherent optical receiver 100 (FIG. 1) according to an embodiment. More specifically, circuit 700 operates to recover the data encoded in modulated optical input signal 102 by processing electrical output signal 152 generated by optical receiver 100, e.g., as indicated above. A recovered data stream 730 can then be provided to external circuits (not explicitly shown in FIG. 7) as appropriate or necessary.

Circuit 700 comprises a threshold slicer 710 and a clock-recovery circuit 720. Clock-recovery circuit 720 is configured to generate a clock signal 722 that is synchronous with the internal clock of optical input signal 102 by processing a copy of electrical output signal 152, e.g., as known in the pertinent art. Clock signal 722 is applied to slicer 710 to cause the slicer to sample electrical output signal 152 at appropriate times. Slicer 710 is configured to compare each of the signal samples obtained in this manner with a set of thresholds. Based on the comparison, slicer 710 generates a binary value (e.g., a bitword) representing the signal sample. The sequence of these binary values is data stream 730.

FIG. 8 shows a block diagram of a data-recovery circuit 800 that can be used in conjunction with coherent optical receiver 100 (FIG. 1) according to another embodiment. Circuit 800 comprises an analog-to-digital converter (ADC) 810 and a digital signal processor (DSP) 820. ADC 810 operates to convert electrical output signal 152 into digital form. DSP 820 then processes a stream 812 of digital signal samples generated by ADC 820 to recover the data encoded in modulated optical input signal 102. A recovered data stream 830 can then be provided to external circuits (not explicitly shown in FIG. 8) as appropriate or necessary.

The use of digital signal processing provided by circuit 800 may be beneficial in some embodiments, e.g., due to the concomitant ability to apply digital equalization and/or forward-error correction. In addition, circuit 800 can be used to decode both intensity- and amplitude-encoded signals, e.g., because the square-root (SQRT) function can be performed in the digital domain instead of being performed in the analog domain as depicted in FIGS. 3 and 5.

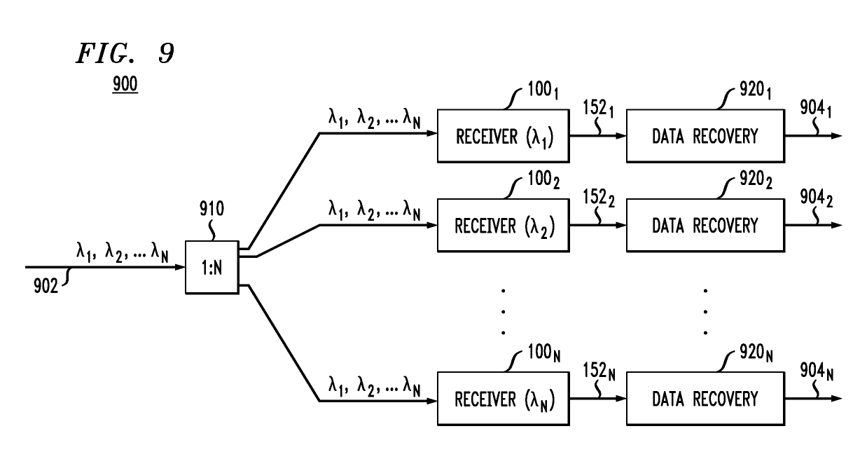

FIG. 9 shows a block diagram of a communication system 900 according to an embodiment. System 900 comprises N instances (nominal copies) of coherent optical receiver 100 (FIG. 1), where N is a positive integer greater than one. The N instances of coherent optical receiver 100 are labeled in FIG. 9 as 100₁-100_{N}, respectively. Each of receivers 100₁-100_{N} is configured to detect an optical input signal having a respective one of wavelengths λ₁-λ_{N}, e.g., by tuning its laser 110 to that particular wavelength. Due to the coherent detection implemented in receiver 100 (see FIG. 1), the receiver can effectively select the input WDM component having the carrier wavelength corresponding to the wavelength of its laser 100, while effectively rejecting all other input WDM components.

System 900 leverages the wavelength selectivity of receivers 100₁-100_{N} by employing a 1:N optical power splitter 910 instead of a normally required wavelength demultiplexer. In operation, splitter 910 splits a WDM signal 902 into N attenuated copies thereof and directs each copy to a respective one of receivers 100₁-100_{N}. Receiver 100₁, which is tuned to wavelength λ₁, detects the λ₁ component of the received copy of signal 902, while rejecting all other wavelength components of that signal. The resulting electrical output signal 152₁ is applied to a data-recovery circuit 920₁, which processes that signal to recover the data encoded in the λ₁ component of signal 902 to generate a corresponding output data stream 904₁. Receiver 100₂, which is tuned to wavelength λ₂, detects the λ₂ component of the received copy of signal 902, while rejecting all other wavelength components of that signal. The resulting electrical output signal 152₂ is applied to a data-recovery circuit 920₂, which processes that signal to recover the data encoded in the λ₂ component of signal 902 to generate a corresponding output data stream 904₂, and so on. Receiver 100_{N}, which is tuned to wavelength λ_{N}, detects the λ_{N} component of the received copy of signal 902, while rejecting all other wavelength components of that signal. The resulting electrical output signal 152_{N} is applied to a data-recovery circuit 920_{N}, which processes that signal to recover the data encoded in the λ_{N} component of signal 902 to generate a corresponding output data stream 904_{N}.

In various embodiments, each of data-recovery circuits 920₁-920_{N} can be implemented using a nominal copy of data-recovery circuit 700 (FIG. 7) or a nominal copy of data-recovery circuit 800 (FIG. 8).

According to an example embodiment disclosed above in reference to FIGS. 1-9, provided is an apparatus (e.g., 900, FIG. 9) comprising: an optical hybrid (e.g., 126, FIG. 1) configured to generate a plurality of different optical interference signals by optically mixing an optical input signal (e.g., 102, FIG. 1) and an optical local-oscillator signal (e.g., 112, FIG. 1); a plurality of photodetectors (e.g., 140₁-140₈, FIG. 1; four pairs of 640, FIG. 6), each configured to generate a respective electrical signal (e.g., 142, FIG. 1; 642, FIG. 6) in response to receiving a respective subset of the different optical interference signals from the optical hybrid; an analog electrical circuit (e.g., 150, FIG. 1; 626/610, FIG. 6) connected to the plurality of photodetectors to generate an electrical output signal (e.g., 152, FIGS. 1, 6) at an output port (e.g., P, FIG. 1) thereof in response to at least four of the respective electrical signals; and wherein the analog electrical circuit comprises a first transimpedance amplifier (e.g., 210, FIGS. 2-5; 610, FIG. 6) connected between the plurality of photodetectors and the output port.

In some embodiments of the above apparatus, the apparatus further comprises a data-recovery circuit (e.g., 920, FIG. 9) configured to recover data encoded in the optical input signal by processing the electrical output signal generated by the analog electrical circuit.

In some embodiments of any of the above apparatus, the data-recovery circuit comprises: a clock-recovery circuit (e.g., 720, FIG. 7) configured to generate a clock signal (e.g., 722, FIG. 7) corresponding to the optical input signal in response to receiving the electrical output signal; and a slicer circuit (e.g., 710, FIG. 7) configured to compare samples of the electrical output signal with a set of thresholds to recover the data, the samples being acquired at times selected using the clock signal.

In some embodiments of any of the above apparatus, the data-recovery circuit comprises: an analog-to-digital converter (e.g., 810, FIG. 8) configured to generate a stream (e.g., 812, FIG. 8) of digital samples representing the electrical output signal; and a digital signal processor (e.g., 820, FIG. 8) configured to recover the data using the stream of digital samples.

In some embodiments of any of the above apparatus, the analog electrical circuit further comprises three additional transimpedance amplifiers (e.g., 210₂-210₄, FIGS. 2-5) connected between the plurality of photodetectors and the output port.

In some embodiments of any of the above apparatus, the analog electrical circuit further comprises four tunable phase shifters (e.g., 220₁-220₄, FIGS. 2-5), each connected to an output of a respective one of the first and three additional transimpedance amplifiers.

In some embodiments of any of the above apparatus, the first transimpedance amplifier comprises: a positive input connected to a first photodetector (e.g., 140₁, FIG. 1) of the plurality of photodetectors to receive the respective electrical signal (e.g., 142₁, FIG. 2) generated by the first photodetector; and a negative input connected to a second photodetector (e.g., 140₂, FIGS. 1-2) of the plurality of photodetectors to receive the respective electrical signal (e.g., 142₂, FIG. 2) generated by the second photodetector.

In some embodiments of any of the above apparatus, the analog electrical circuit is configured to generate the electrical output signal at the output port thereof in response to eight of the respective electrical signals (e.g., 142₁-142₈, FIG. 2).

In some embodiments of any of the above apparatus, the plurality of photodetectors comprises eight photodiodes (e.g., 140₁-140₈, FIG. 1).

In some embodiments of any of the above apparatus, the first transimpedance amplifier (e.g., 610, FIG. 6) is configured to generate the electrical output signal at an output thereof, said output being connected to the output port of the analog electrical circuit.

In some embodiments of any of the above apparatus, the optical hybrid is configured to generate first, second, third, and fourth optical interference signals of the plurality of different optical interference signals using different respective combinations of light of a first polarization (e.g., v, FIG. 1) of the optical input signal and the optical local-oscillator signal.

In some embodiments of any of the above apparatus, the optical hybrid is configured to generate fifth, sixth, seventh, and eighth optical interference signals of the plurality of different optical interference signals using different respective combinations of light of a second polarization (e.g., h, FIG. 1) of the optical input signal and the optical local-oscillator signal, the second polarization being orthogonal to the first polarization.

In some embodiments of any of the above apparatus, each of the different respective combinations of the light are mixtures of the light of the first polarization of the optical input signal and the optical local-oscillator signal with relative phases of 0±5 degrees, 90±5 degrees, 180±5 degrees, and 270±5 degrees, respectively.

In some embodiments of any of the above apparatus, the apparatus further comprises a laser (e.g., 110, FIG. 1) configured to generate the optical local-oscillator signal.

In some embodiments of any of the above apparatus, the laser is capable of controllably changing a carrier wavelength of the optical local-oscillator signal.

In some embodiments of any of the above apparatus, the analog electrical circuit is configured to generate the electrical output signal in a manner (e.g., according to Eq. (1)) that causes the electrical output signal to be proportional to an optical power of the optical input signal.

In some embodiments of any of the above apparatus, the analog electrical circuit comprises: a squaring circuit (e.g., 230₁-230₄, FIG. 2) configured to generate: a first electrical signal whose amplitude is proportional to a square of an amplitude of an electrical signal (e.g., 222₁, FIG. 2) generated using a first photodetector of the plurality of photodetectors; a second electrical signal whose amplitude is proportional to a square of an amplitude of an electrical signal (e.g., 222₂, FIG. 2) generated using a second photodetector of the plurality of photodetectors; a third electrical signal whose amplitude is proportional to a square of an amplitude of an electrical signal (e.g., 222₃, FIG. 2) generated using a third photodetector of the plurality of photodetectors; and a fourth electrical signal whose amplitude is proportional to a square of an amplitude of an electrical signal (e.g., 222₄, FIG. 2) generated using a fourth photodetector of the plurality of photodetectors; and an adding circuit (e.g., 240₁-240₃, FIG. 2) configured to generate the electrical output signal using a sum of the first, second, third, and fourth electrical signals.

In some embodiments of any of the above apparatus, the analog electrical circuit comprises: a squaring circuit (e.g., 230₁-230₄, FIG. 3) configured to generate: a first electrical signal whose amplitude is proportional to a square of an amplitude of an electrical signal (e.g., 222₁, FIG. 2) generated using a first photodetector of the plurality of photodetectors; a second electrical signal whose amplitude is proportional to a square of an amplitude of an electrical signal (e.g., 222₂, FIG. 3) generated using a second photodetector of the plurality of photodetectors; a third electrical signal whose amplitude is proportional to a square of an amplitude of an electrical signal (e.g., 222₃, FIG. 3) generated using a third photodetector of the plurality of photodetectors; and a fourth electrical signal whose amplitude is proportional to a square of an amplitude of an electrical signal (e.g., 222₄, FIG. 3) generated using a fourth photodetector of the plurality of photodetectors; a first adding circuit (e.g., 240₁-240₂, FIG. 3) configured to generate: a first summed signal using a sum of the first electrical signal and the second electrical signal; and a second summed signal using a sum of the third electrical signal and the fourth electrical signal; a square-root-generating circuit (e.g., 310₁-310₂, FIG. 3) configured to generate: a first square-root signal proportional to a square root of the first summed signal; and a second square-root signal proportional to a square root of the second summed signal; and a second adding circuit (e.g., 240₃, FIG. 3) configured to generate the electrical output signal using a sum of the first square-root signal and the second square-root signal.

In some embodiments of any of the above apparatus, the analog electrical circuit comprises: a first adding circuit (e.g., 240₁-240₂, FIG. 4) configured to generate: a first summed signal (e.g., 442₁, FIG. 4) using a sum of an electrical signal (e.g., 222₁, FIG. 4) generated using a first photodetector of the plurality of photodetectors and an electrical signal (e.g., 222₃, FIG. 4) generated using a second photodetector of the plurality of photodetectors; and a second summed signal (e.g., 442₂, FIG. 4) using a sum of an electrical signal (e.g., 222₂, FIG. 4) generated using a third photodetector of the plurality of photodetectors and an electrical signal (e.g., 222₄, FIG. 4) generated using a fourth photodetector of the plurality of photodetectors; a squaring circuit (e.g., 230₁-230₂, FIG. 4) configured to generate: a first electrical signal (e.g., 432₁, FIG. 4) whose amplitude is proportional to a square of an amplitude of the first summed signal; and a second electrical signal (e.g., 432₂, FIG. 4) whose amplitude is proportional to a square of an amplitude of the second summed signal; and a second adding circuit (e.g., 240₃, FIG. 4) configured to generate the electrical output signal using a sum of the first electrical signal and the second electrical signal.

In some embodiments of any of the above apparatus, the analog electrical circuit comprises: a first adding circuit (e.g., 240₁-240₂, FIG. 5) configured to generate: a first summed signal (e.g., 442₁, FIG. 5) using a sum of an electrical signal (e.g., 222₁, FIG. 5) generated using a first photodetector of the plurality of photodetectors and an electrical signal (e.g., 222₃, FIG. 5) generated using a second photodetector of the plurality of photodetectors; and a second summed signal (e.g., 442₂, FIG. 5) using a sum of an electrical signal (e.g., 222₂, FIG. 5) generated using a third photodetector of the plurality of photodetectors and an electrical signal (e.g., 222₄, FIG. 5) generated using a fourth photodetector of the plurality of photodetectors; a squaring circuit (e.g., 230₁-230₂, FIG. 5) configured to generate: a first electrical signal (e.g., 432₁, FIG. 5) whose amplitude is proportional to a square of an amplitude of the first summed signal; and a second electrical signal (e.g., 432₂, FIG. 5) whose amplitude is proportional to a square of an amplitude of the second summed signal; a second adding circuit (e.g., 240₃, FIG. 5) configured to generate a third summed signal (e.g., 240₃, FIG. 5) using a sum of the first electrical signal and the second electrical signal; and a square-root-generating circuit (e.g., 310, FIG. 5) configured to generate the electrical output signal to be proportional to a square root of the third summed signal.

According to another example embodiment disclosed above in reference to FIGS. 1-9, provided is a manufacturing method comprising the steps of: configuring an optical hybrid (e.g., 126, FIG. 1) to generate a plurality of different optical interference signals by optically mixing an optical input signal (e.g., 102, FIG. 1) and an optical local-oscillator signal (e.g., 112, FIG. 1); connecting a plurality of photodetectors (e.g., 140₁-140₈, FIG. 1; four pairs of 640, FIG. 6) to cause each of the photodetectors to generate a respective electrical signal (e.g., 142, FIG. 1; 642, FIG. 6) in response to receiving a respective subset of the different optical interference signals from the optical hybrid; and connecting an analog electrical circuit (e.g., 150, FIG. 1; 626/610, FIG. 6) to the plurality of photodetectors to cause the analog electrical circuit to generate an electrical output signal (e.g., 152, FIGS. 1, 6) at an output port (e.g., P, FIG. 1) thereof in response to at least four of the respective electrical signals, said connecting including connecting a transimpedance amplifier (e.g., 210, FIGS. 2-5; 610, FIG. 6) between the plurality of photodetectors and the output port.

According to yet another example embodiment disclosed above in reference to FIGS. 1-9, provided is a communication method comprising the steps of: applying an optical input signal (e.g., 102, FIG. 1) to an optical hybrid (e.g., 126, FIG. 1) to generate a plurality of different optical interference signals by optically mixing therein said optical input signal and an optical local-oscillator signal (e.g., 112, FIG. 1); operating a plurality of photodetectors (e.g., 140₁-140₈, FIG. 1; four pairs of 640, FIG. 6) to cause each of the photodetectors to generate a respective electrical signal (e.g., 142, FIG. 1; 642, FIG. 6) in response to receiving a respective subset of the different optical interference signals from the optical hybrid; and generating an electrical output signal (e.g., 152, FIGS. 1, 6) using an analog electrical circuit (e.g., 150, FIG. 1; 626/610, FIG. 6) connected to the plurality of photodetectors, the electrical output signal being generated at an output port (e.g., P, FIG. 1) of the analog electrical circuit in response to at least four of the respective electrical signals, said generating including using a transimpedance amplifier (e.g., 210, FIGS. 2-5; 610, FIG. 6) connected between the plurality of photodetectors and the output port.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. An apparatus comprising:
an optical hybrid configured to generate a plurality of different optical interference signals by optically mixing an optical input signal and an optical local-oscillator signal;
a plurality of photodetectors, each configured to generate a respective electrical signal in response to receiving a respective subset of the different optical interference signals from the optical hybrid; and
an analog electrical circuit connected to the plurality of photodetectors to generate an electrical output signal at an output port thereof in response to at least four of the respective electrical signals; and
wherein the analog electrical circuit comprises a first transimpedance amplifier connected between the plurality of photodetectors and the output port.

2. The apparatus of claim 1, further comprising a data-recovery circuit configured to recover data encoded in the optical input signal by processing the electrical output signal generated by the analog electrical circuit.

3. The apparatus of claim 2, wherein the data-recovery circuit comprises:
a clock-recovery circuit configured to generate a clock signal corresponding to the optical input signal in response to receiving the electrical output signal; and
a slicer circuit configured to compare samples of the electrical output signal with a set of thresholds to recover the data, the samples being acquired at times selected using the clock signal.

4. The apparatus of claim 2, wherein the data-recovery circuit comprises:
an analog-to-digital converter configured to generate a stream of digital samples representing the electrical output signal; and
a digital signal processor configured to recover the data using the stream of digital samples.

5. The apparatus of claim 1, wherein the analog electrical circuit further comprises:
three additional transimpedance amplifiers connected between the plurality of photodetectors and the output port; and
four tunable phase shifters, each connected to an output of a respective one of the first and three additional transimpedance amplifiers.

6. The apparatus of claim 1, wherein the first transimpedance amplifier comprises:
a positive input connected to a first photodetector of the plurality of photodetectors to receive the respective electrical signal generated by the first photodetector; and
a negative input connected to a second photodetector of the plurality of photodetectors to receive the respective electrical signal generated by the second photodetector.

7. The apparatus of claim 1, wherein the analog electrical circuit is configured to generate the electrical output signal at the output port thereof in response to eight of the respective electrical signals.

8. The apparatus of claim 1, wherein the plurality of photodetectors comprises eight photodiodes.

9. The apparatus of claim 1, wherein the first transimpedance amplifier is configured to generate the electrical output signal at an output thereof, said output being connected to the output port of the analog electrical circuit.

10. The apparatus of claim 1, wherein the optical hybrid is configured to generate first, second, third, and fourth optical interference signals of the plurality of different optical interference signals using different respective combinations of light of a first polarization of the optical input signal and the optical local-oscillator signal.

11. The apparatus of claim 10, wherein the optical hybrid is configured to generate fifth, sixth, seventh, and eighth optical interference signals of the plurality of different optical interference signals using different respective combinations of light of a second polarization of the optical input signal and the optical local-oscillator signal, the second polarization being orthogonal to the first polarization.

12. The apparatus of claim 10, wherein each of the different respective combinations of the light are mixtures of the light of the first polarization of the optical input signal and the optical local-oscillator signal with relative phases of 0±5 degrees, 90±5 degrees, 180±5 degrees, and 270±5 degrees, respectively.

13. The apparatus of claim 1, further comprising a laser configured to generate the optical local-oscillator signal.

14. The apparatus of claim 13, wherein the laser is capable of controllably changing a carrier wavelength of the optical local-oscillator signal.

15. The apparatus of claim 1, wherein the analog electrical circuit is configured to generate the electrical output signal in a manner that causes the electrical output signal to be proportional to an optical power of the optical input signal.

16. The apparatus of claim 1, wherein the analog electrical circuit comprises:
a squaring circuit configured to generate:
a first electrical signal whose amplitude is proportional to a square of an amplitude of an electrical signal generated using a first photodetector of the plurality of photodetectors;
a second electrical signal whose amplitude is proportional to a square of an amplitude of an electrical signal generated using a second photodetector of the plurality of photodetectors;
a third electrical signal whose amplitude is proportional to a square of an amplitude of an electrical signal generated using a third photodetector of the plurality of photodetectors; and
a fourth electrical signal whose amplitude is proportional to a square of an amplitude of an electrical signal generated using a fourth photodetector of the plurality of photodetectors; and
an adding circuit configured to generate the electrical output signal using a sum of the first, second, third, and fourth electrical signals.

17. The apparatus of claim 1, wherein the analog electrical circuit comprises:
a squaring circuit configured to generate:
a first electrical signal whose amplitude is proportional to a square of an amplitude of an electrical signal generated using a first photodetector of the plurality of photodetectors;
a second electrical signal whose amplitude is proportional to a square of an amplitude of an electrical signal generated using a second photodetector of the plurality of photodetectors;
a third electrical signal whose amplitude is proportional to a square of an amplitude of an electrical signal generated using a third photodetector of the plurality of photodetectors; and
a fourth electrical signal whose amplitude is proportional to a square of an amplitude of an electrical signal generated using a fourth photodetector of the plurality of photodetectors;
a first adding circuit configured to generate:
a first summed signal using a sum of the first electrical signal and the second electrical signal; and
a second summed signal using a sum of the third electrical signal and the fourth electrical signal;
a square-root-generating circuit configured to generate:
a first square-root signal proportional to a square root of the first summed signal; and
a second square-root signal proportional to a square root of the second summed signal; and
a second adding circuit configured to generate the electrical output signal using a sum of the first square-root signal and the second square-root signal.

18. The apparatus of claim 1, wherein the analog electrical circuit comprises:
a first adding circuit configured to generate:
a first summed signal using a sum of an electrical signal generated using a first photodetector of the plurality of photodetectors and an electrical signal generated using a second photodetector of the plurality of photodetectors; and
a second summed signal using a sum of an electrical signal generated using a third photodetector of the plurality of photodetectors and an electrical signal generated using a fourth photodetector of the plurality of photodetectors;
a squaring circuit configured to generate:
a first electrical signal whose amplitude is proportional to a square of an amplitude of the first summed signal; and
a second electrical signal whose amplitude is proportional to a square of an amplitude of the second summed signal; and
a second adding circuit configured to generate the electrical output signal using a sum of the first electrical signal and the second electrical signal.

19. A manufacturing method comprising:
configuring an optical hybrid to generate a plurality of different optical interference signals by optically mixing an optical input signal and an optical local-oscillator signal;
connecting a plurality of photodetectors to cause each of the photodetectors to generate a respective electrical signal in response to receiving a respective subset of the different optical interference signals from the optical hybrid; and
connecting an analog electrical circuit to the plurality of photodetectors to cause the analog electrical circuit to generate an electrical output signal at an output port thereof in response to at least four of the respective electrical signals, said connecting including connecting a transimpedance amplifier between the plurality of photodetectors and the output port.

20. A communication method comprising:
applying an optical input signal to an optical hybrid to generate a plurality of different optical interference signals by optically mixing therein said optical input signal and an optical local-oscillator signal;
operating a plurality of photodetectors to cause each of the photodetectors to generate a respective electrical signal in response to receiving a respective subset of the different optical interference signals from the optical hybrid; and
generating an electrical output signal using an analog electrical circuit connected to the plurality of photodetectors, the electrical output signal being generated at an output port of the analog electrical circuit in response to at least four of the respective electrical signals, said generating including using a transimpedance amplifier connected between the plurality of photodetectors and the output port.
